(19) United States
(12) Patent Application Publication
(10) Pub. No.: US 2006/0141635 A1
(43) Pub. Date: Jun. 29, 2006

(54) Method and apparatus for preprocessing sample according to form by hydride introduction method

(75) Inventor: Yasuhito Taneike, Yasu-shi (JP)

Correspondence Address: KANESAKA BERNER AND PARTNERS LLP, SUITE 300, 1700 DIAGONAL RD, ALEXANDRIA, VA, 22314-2848, US

(73) Assignee: SHIMADZU CORPORATION, Kyoto (JP)

(21) Appl. No.: 11/022,879

(22) Filed: Dec. 28, 2004

(51) Int. Cl. G01N 1/00

(52) U.S. Cl. 436/174

(57) ABSTRACT

A sample preprocessing method converts a substance to be measured in a sample solution into a volatile hydride and introduces the substance into an analytical device. The method includes the following steps (A) to (D) to be performed inside a reaction apparatus connected as a series of processes: (A) a step in which a sample solution is measured and is introduced into a reaction tank of the reaction apparatus; (B) a hydrogenation step in which the sample solution and a reagent are reacted in the reaction tank to produce a hydride; (C) a collection step in which the hydride is guided to a cooling trap to be collected; and (D) a separation step according to a form, in which a temperature of the cooling trap is increased to successively separate a hydride with a low boiling point from the hydrides and guiding to the analytical device.

### BACKGROUND OF THE INVENTION AND RELATED ART STATEMENT

The present invention relates to a sample preprocessing method and apparatus for gasifying a substance to be measured in a sample solution and introducing the substance to an analytical device for analysis such as atomic absorption analysis (AA), inductively coupled plasma analysis (ICP), and inductively coupled plasma excitation-mass spectrometry (ICP-MS).

A preprocessing method of introducing a sample into an analytical device includes a hydride generation method, in which a semi-metallic element such as arsenic (As), antimony (Sb) and selenium (Se) is introduced into the analytical device as a volatile hydride. Various compounds having different forms such as chemical bonding states and oxidation states are included in an element to be measured in the sample. In the hydride generation method, all of hydrides are introduced simultaneously into the analytical device regardless of forms.

Another preprocessing method includes an ultra-low temperature collection method. In a case of a sample to be supplied in a gas form, the sample is cooled and concentrated with a coolant such as liquid nitrogen, and then the sample is heated for separation and introduced into an analytical device.

A further preprocessing method includes a separation method according to a form using a boiling point separation method. Various compounds having different forms in a sample are cooled and collected, and then continually heated, so that a compound with a lower boiling point is successively separated and introduced into an analytical device. These preprocessing methods are independent, and each thereof is used separately.

When semi-metallic elements such as As, Sb and Se are analyzed according to a form, each of the hydride generation method, ultra-low temperature collection method, and boiling point separation method is performed separately by a manual operation, and samples separated according to forms are prepared and introduced into an analytical device.

However, when each of the hydride generation method, ultra-low temperature collection method, and boiling point separation method is performed separately by a manual operation, the processing becomes complicated, thereby making stable control difficult and lowering precision of the measurement. Also, it is necessary to independently control each individual method, thereby making a processing time longer. The individual process is performed by a manual operation, thereby increasing a burden on an operator.

In view of the problems described above, an object of the present invention is to provide a method and an apparatus for converting a substance to be measured into a volatile hydride and introducing into an analytical device according to a form, in which an overall process of the preprocessing method is simplified. Accordingly, it is possible to alleviate a burden on an operator, shorten a processing time, and increase precision of measurement.

Further objects and advantages of the invention will be apparent from the following description of the invention.

### SUMMARY OF THE INVENTION

In order to attain the objects described above, according to the present invention, a sample preprocessing method converts a substance to be measured in a sample solution into a volatile hydride and introduces the substance into an analytical device. The method includes the following steps (A) to (D) to be performed inside a reaction apparatus connected with piping as a series of processes:

(A) a step in which a predetermined quantity of a sample solution is measured and is introduced into a reaction tank of the reaction apparatus;

(B) a hydrogenation step in which the sample solution and a reagent for hydrogenation reaction are reacted in the reaction tank to produce a volatile hydride of the substance to be measured;

(C) a collection step in which the hydride is guided to a cooling trap to be collected; and

(D) a separation step according to a form, in which a temperature of the cooling trap is continually increased to successively separate a form having a low boiling point from the collected hydride, and the hydride is guided to the analytical device.

In the sample preprocessing method of the present invention, each of the sample introduction step, the hydride generation step, the ultra-low temperature collection step, and the boiling point separation step is performed inside the reaction apparatus connected with the piping as a series of the processes. Accordingly, the overall process is simplified, thereby reducing a burden on an operator and a processing time, and improving precision of measurement.

A sample preprocessing apparatus for performing the sample preprocessing method comprises: a reaction tank connected at least a sample piping for supplying a sample solution, a reagent piping for supplying a reagent, a carrier gas piping for supplying a carrier gas, and a generated gas piping for extracting generated volatile hydride together with the carrier gas; a sampling mechanism connected to the sample piping for measuring a predetermined quantity of the sample solution and supplying the sample solution to the reaction tank; a reagent supply mechanism connected to the reagent piping for supplying a predetermined quantity of the reagent to the reaction tank; a carrier gas supply mechanism connected to the carrier gas piping for supplying the carrier gas to the reaction tank; and a cooling trap connected to the generated gas piping for cooling and collecting the hydride supplied together with the carrier gas. The cooling trap changes a temperature in a range from a cooling temperature for the collection to a temperature higher than a highest boiling point of a form of the collected hydride.

In the sample preprocessing apparatus of the present invention, a washing fluid piping may be connected to the reaction tank for supplying washing fluid, and a drainage mechanism capable of opening and closing may be connected to a bottom portion of the reaction tank. Accordingly, it is possible to clean the reaction tank before and after each preprocessing operation in a state that the reaction tank is connected to the piping, thereby reducing a burden of the washing operation.

In the present invention, it is preferable that the bottom portion of the reaction tank has a cross section smaller than that of a top portion. Accordingly, it is possible to process a small quantity of a sample solution.

In the present invention, it is preferable that the reaction tank has an agitating mechanism for agitating an internal solution, thereby facilitating the reaction and the washing.

In the present invention, it is preferable that an exit of the carrier gas piping is disposed at the bottom portion of the reaction tank for facilitating a movement of the generated hydride, since the volatile hydride generated from the sample solution moves upwardly, and the generated gas is supplied through the generated gas piping from above.

In the present invention, it is preferable that at least one of a steam trap and a carbonic acid gas trap is disposed on the generated gas piping between the reaction tank and the cooling trap, since steam and carbonic acid gas interfere with the measurement of the hydrides of the substance to be measured.

In the present invention, it is preferable that the sample preprocessing apparatus has a control device for controlling the sample preprocessing method of the present invention. That control device has at least one of a manual mode and an auto mode. In the manual mode, a message indicating an instruction of an operation is displayed and a series of operations is controlled through an operating mode in which the operation is performed upon an input of an instruction. In the auto mode, a series of operations is controlled through an operating mode in which the operations are automatically performed according to a specific timing after the start of operations is instructed.

### BRIEF DESCRIPTION OF THE DRAWINGS

FIG. 1 is a schematic diagram showing a preprocessing apparatus according to an embodiment of the present invention;

FIG. 2 is a flow chart showing an early part of an operation in a manual mode;

FIG. 3 is a flow chart showing a middle part of the operation in the manual mode;

FIG. 4 is a flow chart showing a later part of the operation in the manual mode;

FIG. 5 is a flow chart showing a former half of an operation in an auto mode;

FIG. 6 is a flow chart showing a latter half of the operation in the auto mode;

FIG. 7 is a timing chart showing the early part of the operation in the manual mode;

FIG. 8 is a timing chart showing the middle part of the operation in the manual mode;

FIG. 9 is a timing chart showing the later part of the operation in the manual mode;

FIG. 10 is a timing chart showing an early part of the operation in the auto mode;

FIG. 11 is a timing chart showing a middle part of the operation in the auto mode; and

FIG. 12 is a timing chart showing a later part of the operation in the auto mode.

### DETAILED DESCRIPTION OF PREFERRED EMBODIMENTS

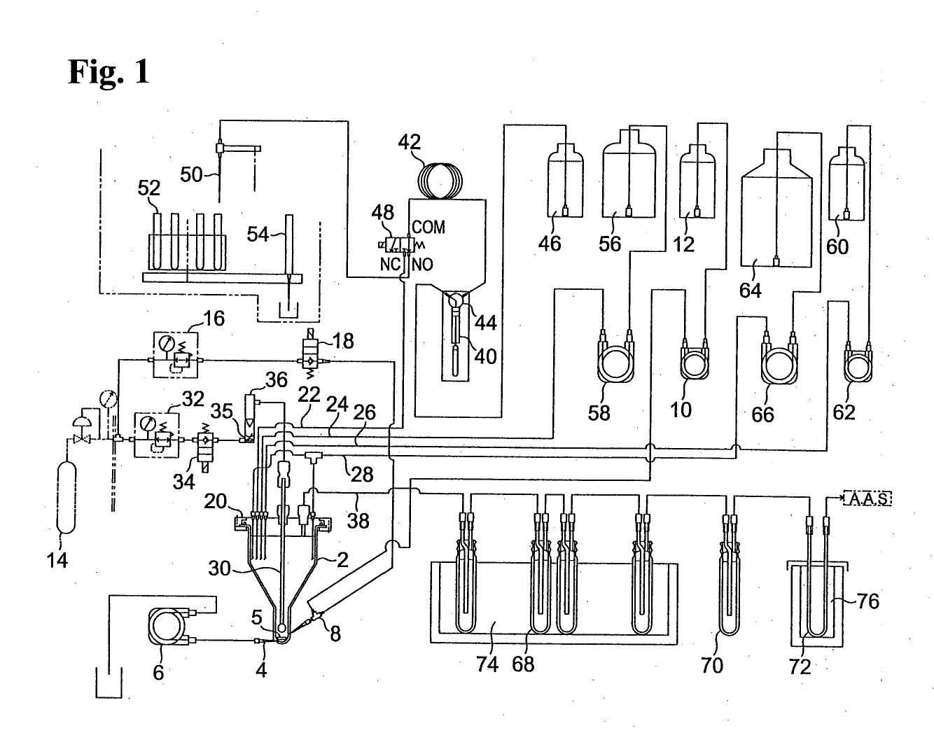

Hereunder, embodiments of the present invention will be explained with reference to the accompanying drawings. FIG. 1 shows a preprocessing apparatus according to an embodiment. A reaction tank 2 has a shape having a bottom portion with a small cross section so that a small amount of a sample solution can be processed. A drainage port 4 is provided on the bottom portion of the reaction tank 2, and a drainage pump 6 is provided on the drainage port 4, so that liquid in the reaction tank 2 is drained with a drainage pump 6. A drainage mechanism capable of opening and closing is formed of the drainage port 4 and the drainage pump 6.

An agitator 5 is disposed in the bottom portion of the reaction tank 2. A magnetic drive device is disposed under the bottom portion of the reaction tank 2 for rotating the agitator 5 with a magnetic field to agitate liquid inside the reaction tank 2. On the bottom portion of the reaction tank 2, a reagent piping is connected via an opening-and-closing valve 8 for supplying NaBH₄, i.e., a hydrogenation reagent for converting a substance to be measured into a hydride. A NaBH₄ pump 10 supplies NaBH₄ solution 12 through the reagent piping. Helium gas with a constant pressure regulated by a regulator 16 is supplied from a helium canister 14 through a NaBH₄ injection valve 18 to the opening-and-closing valve 8 to be opened and closed.

A top portion of the reaction tank 2 is closed tightly with a lid 20. A sample piping 22 for supplying a sample solution, a hydrochloric acid piping 24 for supplying hydrochloric acid, an additive piping 26 for supplying an additive, and a washing fluid piping 28 for supplying washing fluid are connected to the lid 20. Exits of the pipings 22, 24, 26 and 28 are positioned inside the top portion of the reaction tank 2.

A syringe 40 and a sample loop 42 are provided as a sampling mechanism for acquiring a sample solution and supplying the sample solution to the reaction tank 2. The syringe 40 is connected to a common port of a syringe valve 44, and the sample loop 42 is connected to a port on one side of the syringe valve 44. Piping connected to distilled water 46 is connected on a port on the other side of the syringe valve 44. The sample loop 42 is connected to a common port (COM) of a sample valve 48. A nozzle 50 for sampling is connected on a normally-open port (NO) of the sample valve 48, and a normally-closed port (NC) of the sample valve 48 is connected to the sample piping 22 connected to the reaction tank 2.

In order to separately inject the sample solution through the nozzle 50, in addition to plural sample containers 52 containing the sample solutions, a washing port 54 is provided for washing the nozzle 50. The nozzle 50 can be inserted into and removed from the sample containers 52 and the washing port 54 manually, as well as automatically using an auto sampler. The auto sampler is used in an auto mode.

The hydrochloric acid piping 24 is connected to the reaction tank 2 so that hydrochloric acid 56 is supplied with a hydrochloric acid pump 58. The additive piping 26 is connected so that an additive 60 is supplied with an additive pump 62. The washing fluid piping 28 is connected so that washing fluid 64 is supplied with a washing pump 66.

In the center part of the lid 20 of the reaction tank 2, a carrier gas supply pipe 30 for supplying a carrier gas is attached, and an exit of the carrier gas supply pipe 30 is positioned near the bottom portion of the reaction tank 2. Helium gas adjusted by a regulator 32 is supplied from the helium canister 14 to the carrier gas supply pipe 30 via an opening-and-closing valve 34, a flow regulator 35, and a flow meter 36.

In order to extract a volatile hydride produced inside the reaction tank 2 together with the carrier gas, i.e., helium gas, a generated gas piping 38 is attached to the lid 20, and a port of the generated gas piping 38 is positioned at the top portion inside the reaction tank 2. Four steam traps 68 arranged in series are connected to the generated gas piping 38. The steam traps 68 are cooled to −20° C. by a coolant 74, so that moisture within gas flowing through the generated gas piping 38 is condensed and collected.

A carbonic acid gas trap 70 is connected at a downstream side of the steam traps 68 for collecting and trapping carbonic acid with granular NaOH filled therein. The carbonic acid trap 70 can be omitted. A cooling trap 72 is connected at a downstream side of the carbonic acid trap 70 for cooling and collecting the hydrides. The cooling trap 72 is formed of a U-shaped pipe filled with quartz glass wool, and can be cooled to about −190° C. with liquid nitrogen 76 as a coolant. A temperature of the cooling trap 72 can be returned to a room temperature by removing the U-shaped pipe from the liquid nitrogen 76. An analytical device such as an atomic absorption spectrometer is connected at a downstream side of the cooling trap 72.

In the cooling trap 72, all of the volatile semi-metallic hydrides are condensed and collected at the liquid nitrogen temperature. By removing the U-shaped pipe from the liquid nitrogen 76, the temperature of the cooling trap 72 continually rises. With the increase in the temperature, a form having a lower boiling point is successively separated from the collected hydrides and guided to the analytical device, thereby separating the hydrides according to a form.

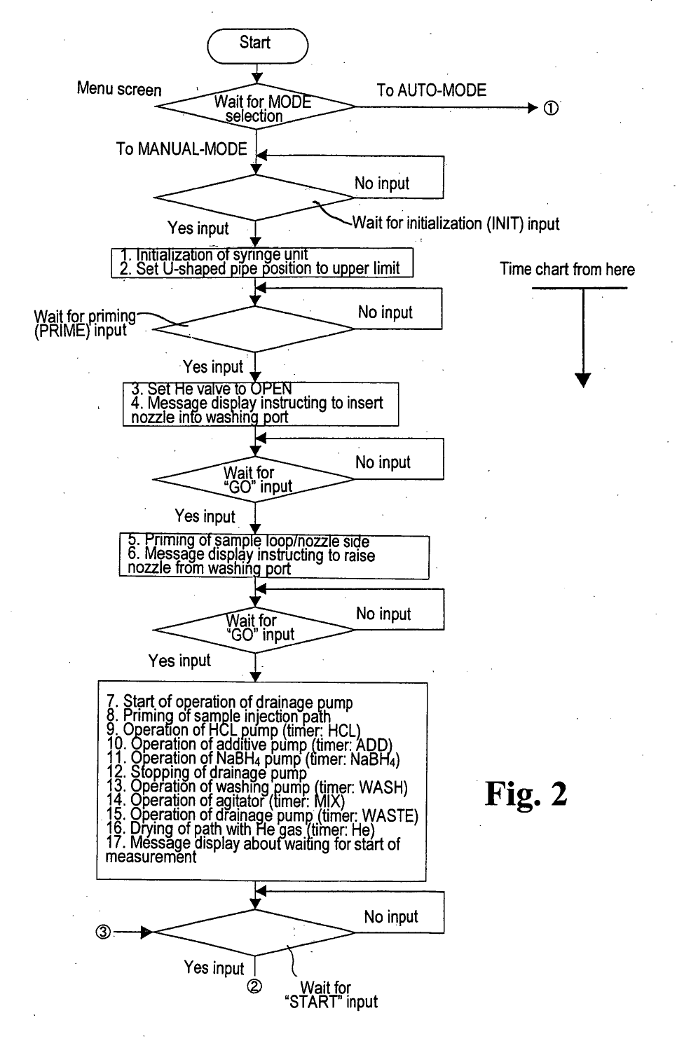

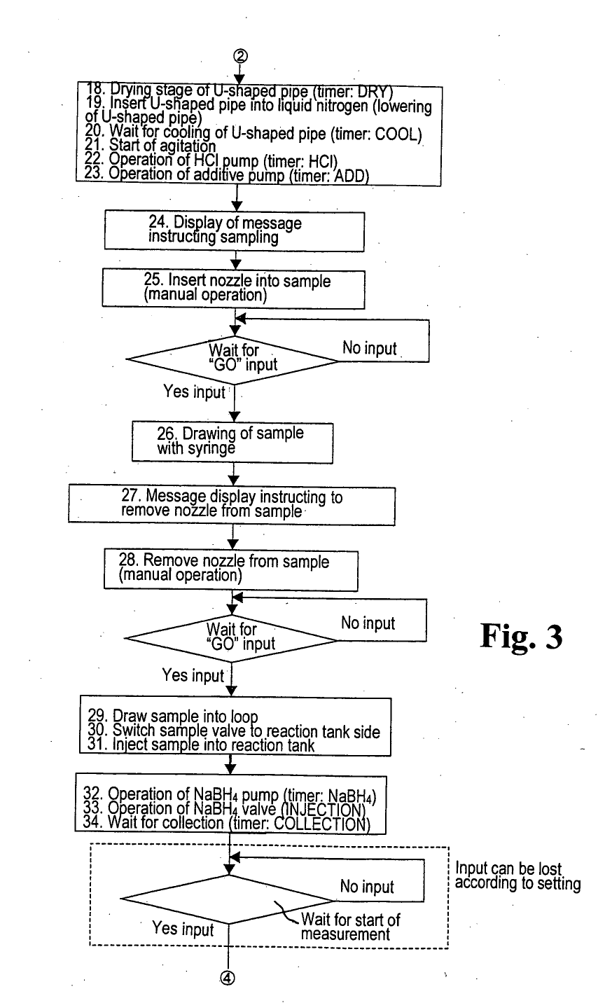

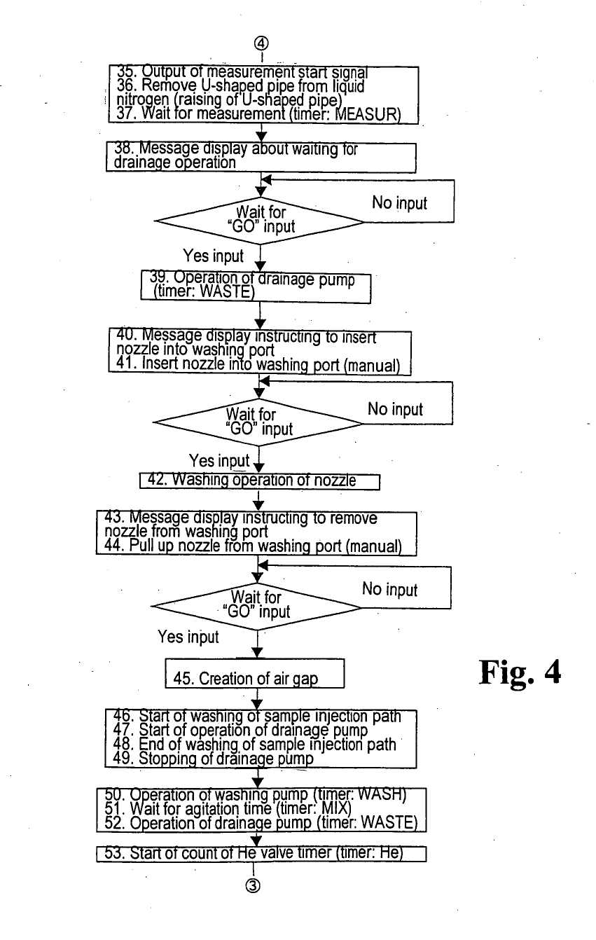

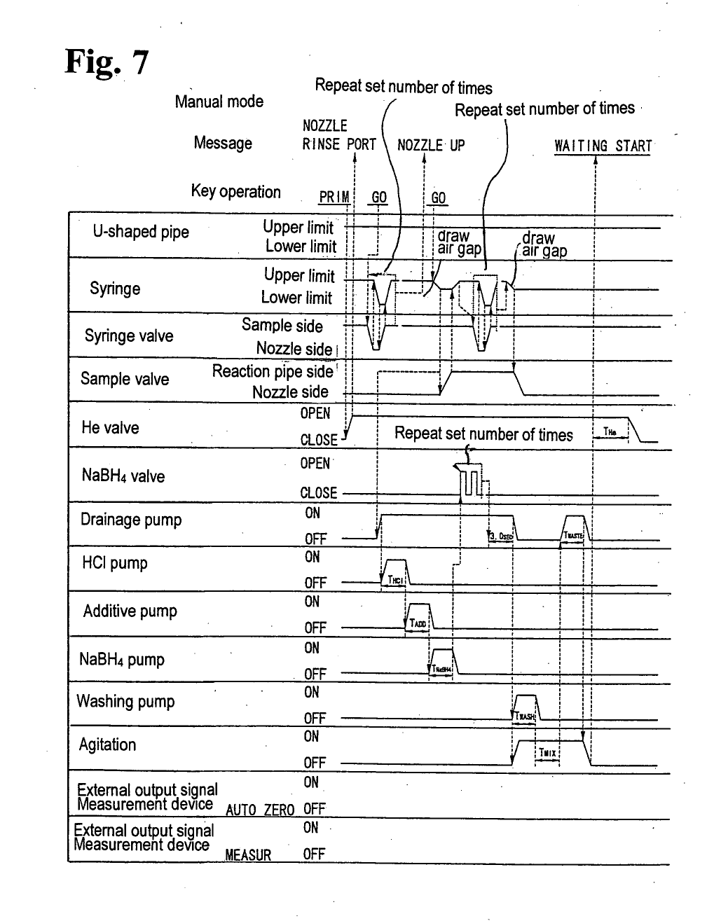

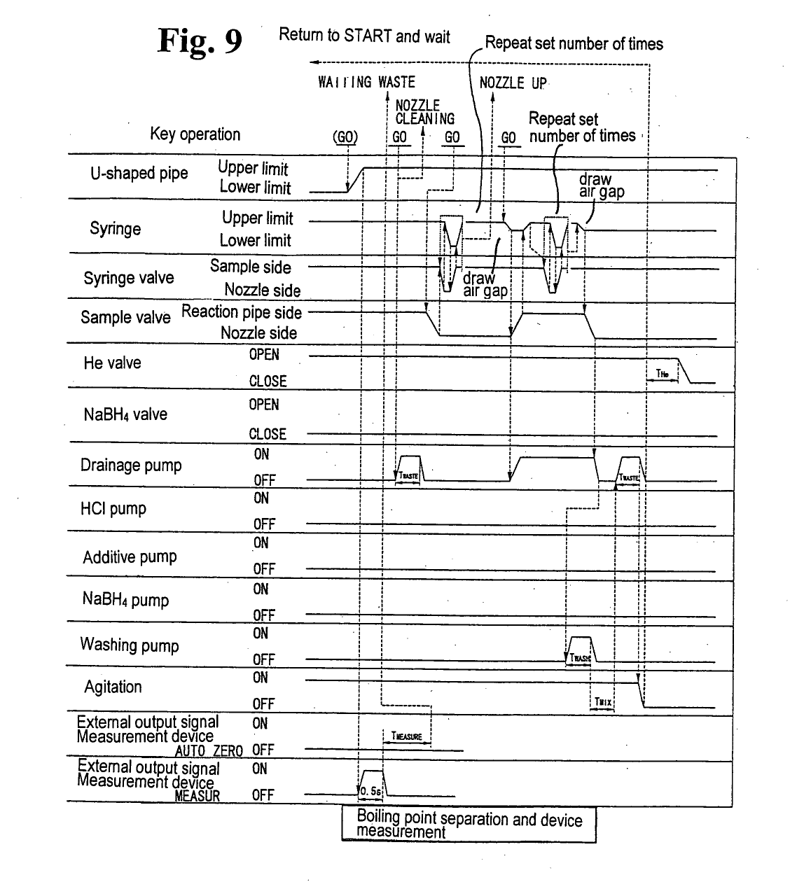

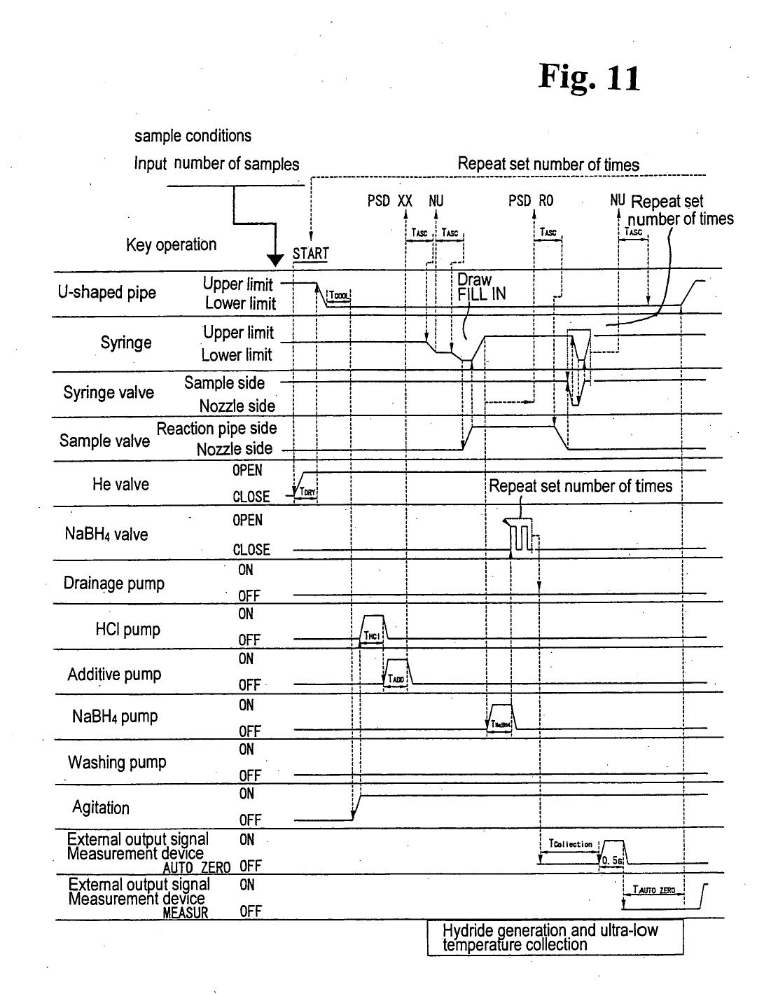

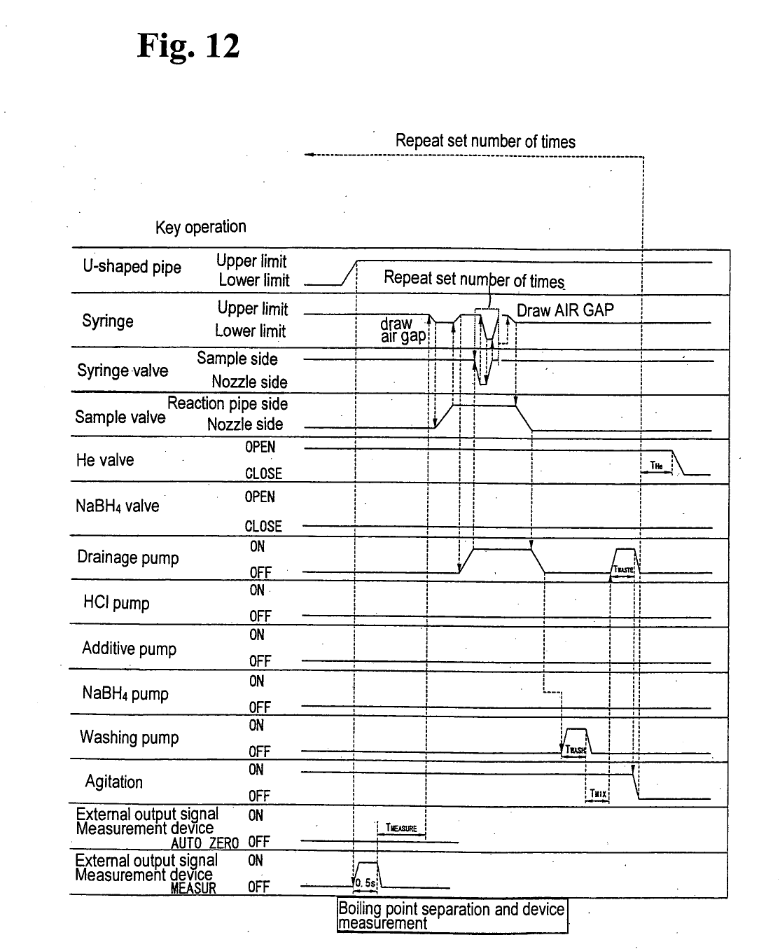

An operation of the apparatus will be explained next based on the flow charts shown in FIGS. 2 to 6 and the timing charts shown in FIGS. 7 to 12. In the present embodiment, there are two operational modes, i.e., a manual mode in which messages regarding plural operations are displayed, and an operator instructs the operations through a key operation in response to the messages and also performs a portion of the operations manually, and an auto mode in which when a start of the operations is instructed through the key operation, the operations are automatically performed according to an established timing. It is possible to select one of the operating modes from a menu screen.

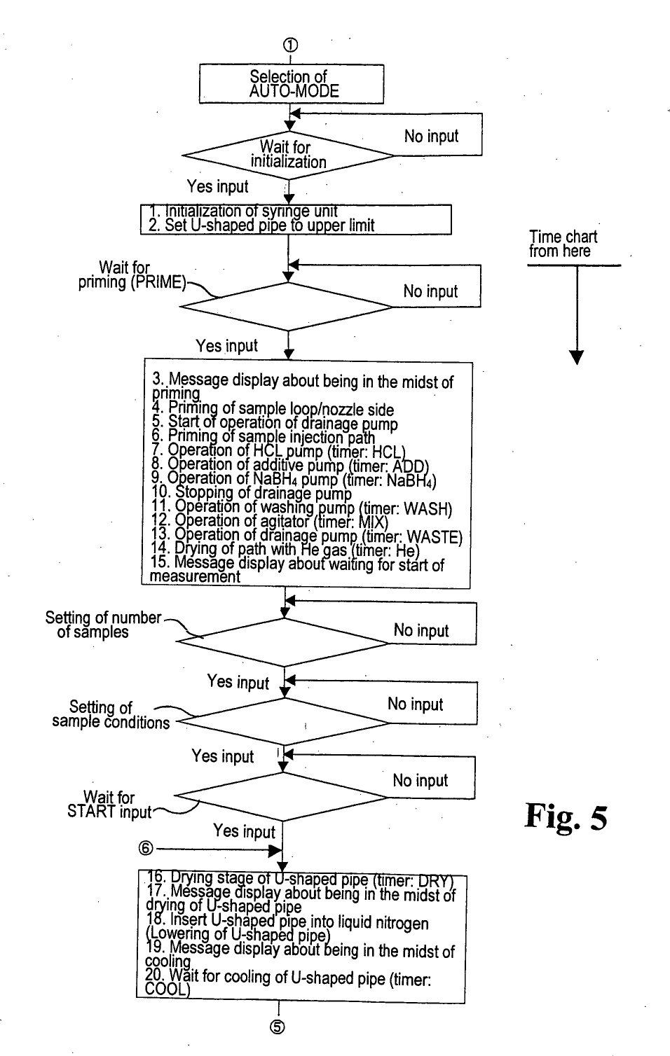

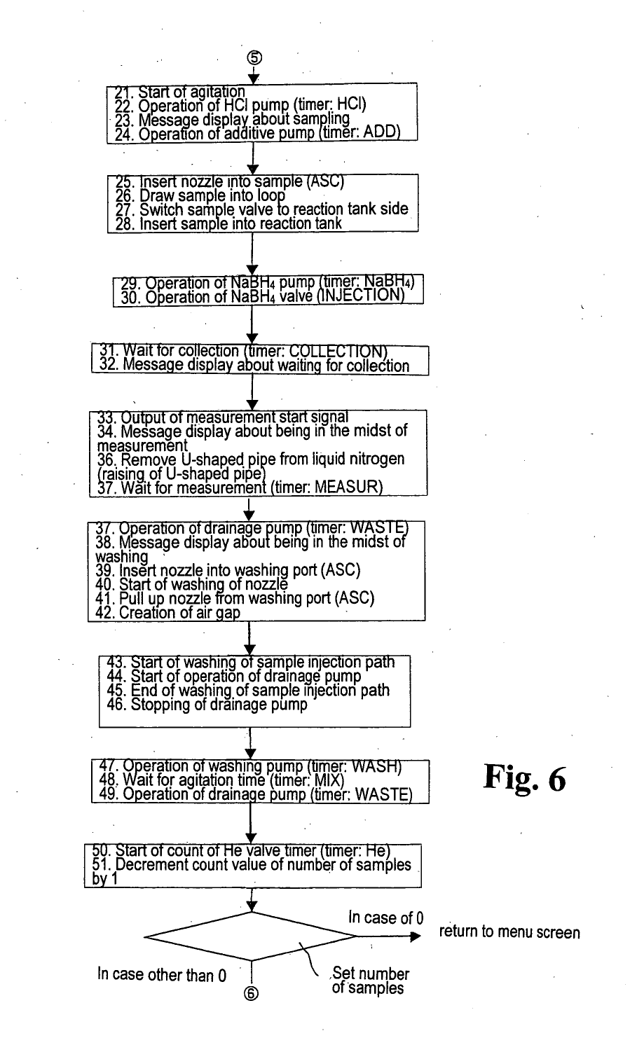

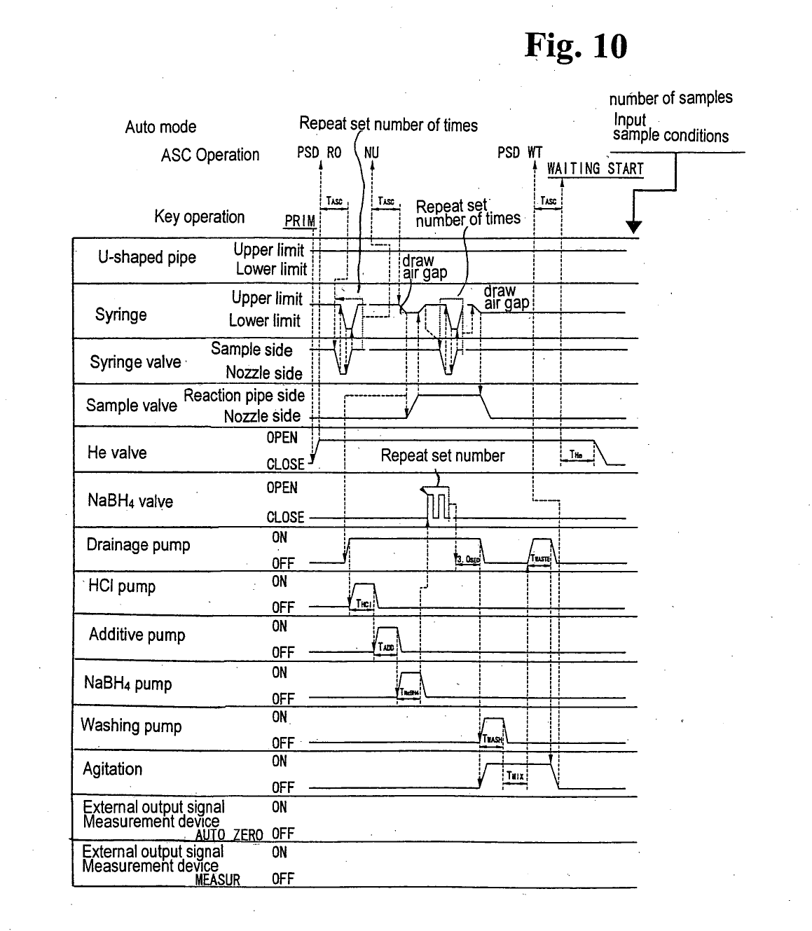

The operations in the manual mode are shown in FIGS. 2 to 4 and 7 to 9, and the operations in the auto mode are shown in FIGS. 5, 6 and 10 to 12. FIGS. 2 to 4 are a series of the flow charts, and FIGS. 5, 6 are also a series of the flow charts. FIGS. 7 to 9 are a series of the timing charts, and FIGS. 10 to 12 are also a series of the timing charts. The timing charts include partially overlapped portions at connected parts of each drawing.

In the present invention, it is important to dry the quartz glass wool packed inside the U-shaped pipe of the cooling trap 72 for collecting the hydrides. Accordingly, the carrier gas, i.e., helium gas, is always flowing before and during the use for facilitating the drying. When the power is turned on, a menu screen appears on the display, and the operator selects one of the manual mode and the auto mode.

When the manual mode is selected, the operations are performed according to the flow charts shown in FIGS. 2 to 5 and the timing charts shown in FIG. 7 to 9. Initialization is performed before the sample preprocessing operation in the initialization, washing fluid is filled into a channel for supplying the samples, and the respective samples are filled into the sample piping. Then, the reaction tank 2 is washed for the sample preprocessing operation.

First, the initialization will be explained. When the operator performs a key input to start the initialization, the syringe 40 is positioned at the upper limit position, and initialization of the syringe unit is performed (step 1). The U-shaped pipe of the cooling trap 72 is located at the upper limit (step 2). In the flow charts, numbers represent step numbers, and are noted as step No in the specification.

When the operator inputs priming “PRIME” through the key operation, the helium valve 34 is opened. Accordingly, helium gas in the canister 14 is sent to the reaction-tank 2, and flows through the cooling trap 72 from the generated gas piping 38 (step 3). A message prompting to insert the nozzle into the washing port is displayed (step 4). When the operator inputs “GO” through the key operation for the next step, in a state in which the sample valve 48 is connected on the nozzle side, a switching of the syringe valve 44 and an operation of the syringe 40 are repeated. Accordingly, the distilled water 46 is discharged from the nozzle 50 to the washing port 54, and the pipings of the sample loop 42 and the nozzle 50 are primed (step 5).

When the priming is completed, a message prompting to remove the nozzle from the washing port is displayed (step 6). When the operator inputs “GO” through the key operation for the next step, the drainage pump 6 starts (step 7). The sample valve 48 is switched to the sample piping 22 (reaction tank side), and the distilled water is discharged into the reaction tank 2 through the piping 22 by the switching of the syringe valve 44 and the operation of the syringe 40. The discharge operation from the discharge pump 6 is repeated a predetermined number of times, thereby priming the piping 22 (step 8).

When the hydrochloric acid pump 58 is operated for a predetermined period of time together with the priming operation of the piping 22, hydrochloric acid is discharged to the reaction tank 2 through the piping 24, and the piping 24 is filled with hydrochloric acid (step 9). When the additive pump 62 is operated for a predetermined period of time, the additive is discharged to the reaction tank 2 through the piping 26, and the piping 26 is filled with the additive (step 10). When the NaBH₄ pump 10 is operated for a predetermined period of time, the NaBH₄ injection valve 18 is repeatedly turned ON and OFF to repeatedly turn ON and OFF the valve 8. Accordingly, NaBH₄ is discharged to the reaction tank 2 from the NaBH₄ piping, so that the NaBH₄ piping is filled with NaBH₄ (step 11).

After a predetermined period of time (for example, three seconds), the drainage pump 6 stops (step 12). The washing pump 66 is operated to supply washing fluid to the reaction tank 2, and the external magnetic drive device drives the agitator 5 to rotate, so that the agitation operation is performed and the inside of the reaction tank 2 is washed (steps 13, 14). After that, the drainage pump 6 is operated to discharge the washing fluid, and the agitation operation is stopped, thereby washing the inside of the reaction tank 2 (step 15). The carrier gas continues to be discharged from a tip of the carrier gas supply pipe 30 for a predetermined period of time. Accordingly, the inside of the reaction tank 2 as well as the generated gas piping 38 and the cooling trap 72 are dried (step 16), thereby completing the initialization. A message of “WAITING START” prompting the start of the preprocessing operation is displayed (step 17).

In the preprocessing operation, when the operator inputs “START” through the key operation, the helium valve 34 is opened. Accordingly, the carrier gas passes through the U-shaped pipe of the cooling trap 72 from the piping 38 via the reaction tank 2, thereby drying the U-shaped pipe for a predetermined period of time (step 18). After that, the U-shaped pipe of the cooling trap 72 is filled with liquid nitrogen 76 (step 19) and is cooled for a predetermined period of time (step 20). Then, the agitator 5 rotates in the reaction tank 2 to start the agitation operation. The hydrochloric acid pump 58 is operated for a predetermined period of time, so that a predetermined quantity of hydrochloric acid is supplied to the reaction tank 2 (steps 21 and 22). The additive pump 62 is operated for a predetermined period of time, so that a predetermined quantity of the additive is added to the reaction tank 2 (step 23).

Upon displaying a message “prompt sampling” (step 24), when the operator manually inserts the nozzle 52 in the sample solution (step 25) and inputs “GO” through the key operation, the syringe 40 is lowered by a predetermined amount and the sample solution is drawn in (step 26). Next, upon displaying a message “NOZZLE UP” prompting to raise the nozzle (step 27), when the operator manually removes the nozzle 50 from the sample solution (step 28) and inputs “GO” through the key operation, the syringe 40 is lowered and the sample solution drawn into the nozzle 50 is transferred into the sample loop 42 (step 29). When the sample valve 48 is switched to the reaction tank side, the syringe 40 rises, and the sample solution inside the sample loop 42 is injected into the reaction tank 2 (steps 30 and 31).

The NaBH₄ pump 10 is operated for a predetermined period of time (step 32) in order to inject the hydrogenation reagent into the reaction tank 2. The NaBH₄ injection valve 18 is repeatedly turned ON and OFF a predetermined number of times, so that a predetermined quantity of NaBH₄ solution is injected into the reaction tank 2 through the valve 8 (step 33). Accordingly, the sample solution reacts with NaBH₄ to generate the hydrides inside the reaction tank 2. The hydrides are guided to the cooling trap 72 through the generated gas piping 38 and collected.

After a predetermined set period of time to complete collection of the hydrides (step 34), the measurement device performs zero level adjustment (auto zero), and then a message prompting the start of the measurement is displayed. When the operator inputs “GO” through the key operation, a measurement start signal is output (step 35). It is also possible to advance to step 35, in which the measurement start signal is output immediately, after the zero level adjustment (auto zero) without inputting “GO” through the key operation by the operator.

When the measurement start signal is output, the U-shaped pipe of the cooling trap 72 is pulled up from the liquid nitrogen (step 36). The hydrides collected in the cooling trap 72 are successively volatized from a form having a lower boiling point for separation. The boiling point separation is performed to successively introduce the hydrides into the measurement device, and measurement is performed for a predetermined period of time (step 37).

Upon displaying a message prompting the drainage operation (step 38), when the operator inputs “GO” through the key operation, the drainage pump 6 is operated to discharge the reaction solution inside the reaction tank 2 (step 39). When a message prompting washing of the nozzle is displayed (step 40), the operator manually puts the nozzle 50 into the washing port 54 (step 41) and then inputs “GO” through the key operation, so that the nozzle 50 is washed through the switching of the syringe valve 44 and the operation of the syringe 40 (step 42).

Upon displaying a message prompting to pull up the nozzle 50 from the washing port 54 (step 43), when the operator manually pulls up the nozzle 50 from the washing port 54 and inputs “GO” through the key operation (step 44), the syringe 40 is lowered and air is drawn into the nozzle 50 to create an air gap (step 45). The sample valve 48 is switched to the reaction tank side, and the drainage pump 6 starts. The sample path including the sample loop 42 and the sample piping 22 is washed by the switching of the syringe valve 44 and the operation of the syringe 40 (steps 46 and 47). After a predetermined period of time, the washing operation is stopped. The sample valve 48 is switched to the nozzle side, and the drainage pump 6 is stopped (steps 48 and 49).

Next, the washing pump 66 is operated for a predetermined period of time to supply washing fluid to the reaction tank 2 (step 50). During this period, the agitator 5 continues agitating. After washing fluid is stopped and the agitator 5 agitates for a predetermined period of time, the drainage pump 6 is operated to discharge the washing fluid inside the reaction tank 2, and the agitator 5 stops (steps 51 and 52). The helium gas valve 34 is opened for a predetermined period of time, and the operation for one sample solution is completed (step 53). The same operation is repeated for the next sample solution.

Operations in the auto mode will be explained-next. In the manual mode, the messages are displayed on the display, and the operator performed the operations according to the messages and inputs the instructions through the key operation. In the auto mode, the operator still performs key input to start the initialization, key input “PRIME” to start the priming operation, and key input “START” to start the preprocessing operation. The subsequent operations are processed automatically while controlling an auto sample changer (ASC). In the auto mode, the auto sampler is used as a mechanism for supplying sample solutions and washing the sampling nozzle.

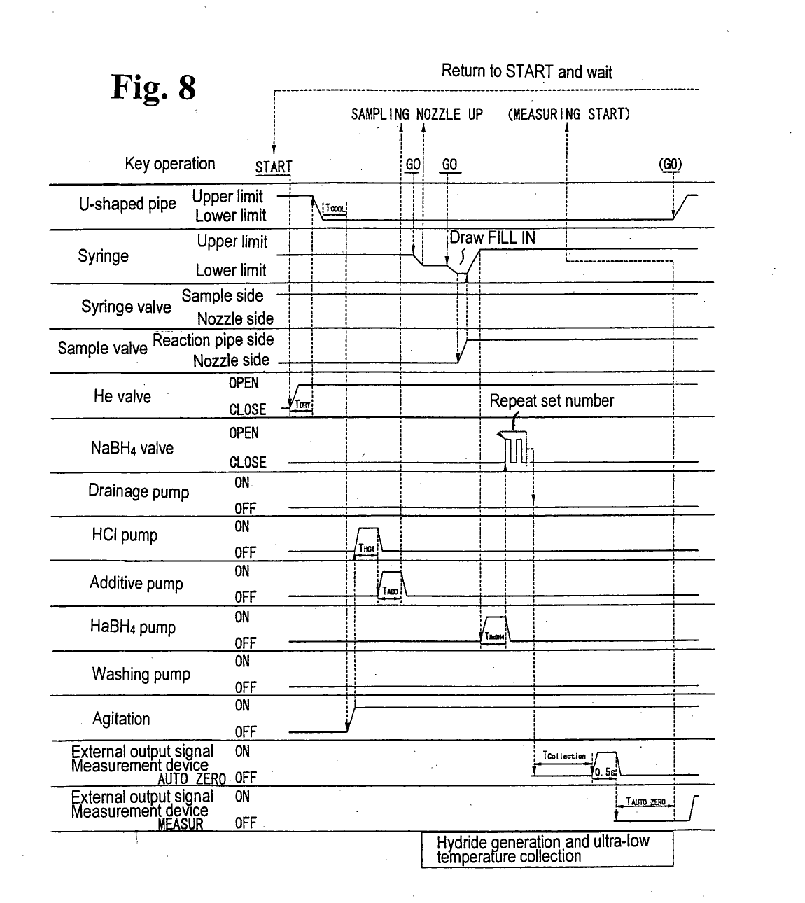

FIGS. 5 and 6 are the flow charts of the operations, and FIGS. 10 to 12 are the timing charts. When the operator inputs to start the initialization, the initialization of the syringe unit is performed to position the syringe 40 at a central position between the upper limit and the lower limit (step 1), and the position of the U-shaped pipe is set to the upper limit (step 2). When the operator inputs “PRIME” to start the priming, the initialization up to step 15 is performed. The operations are the same as those in the manual mode, except that the processing device performs the operations automatically while controlling the auto sampler without the key inputs by the operator. “PSD RD” shown in FIG. 8 is a command transmitted from the processing device to the ASC, in which an arm moves to the washing port (position of RD) and the nozzle lowers. With the transmission of the command, the operation of the ASC becomes in a state in which the nozzle is inserted into the washing port, and the processing device performs the operation of washing the nozzle.

Immediately after the washing operation, “NU” command is transmitted to the ASC, and the ASC becomes in a state in which the nozzle is pulled up from the washing port. After that, the processing device performs the operation of creating an air gap. The operation of filling the pump path and the operation of filling distilled water in the sample injection path are performed in parallel as in the manual mode. When the drainage is completed after the washing operation, “PSD WT” command is transmitted to the ASC, and the ASC moves the nozzle to a waiting position (slightly away from the washing port). After that, the operation of drying the path is performed as in the manual mode.

In the sample preprocessing operation, when the operator inputs the number of the samples and sample conditions, and inputs “START” through the key operation, the helium valve 34 opens, so that the carrier gas passes through the U-shaped pipe of the cooling trap 72 from the generated gas piping 38 via the reaction tank 2, thereby drying the U-shaped pipe for a predetermined period of time, and displaying a message of drying (steps 16 and 17). After that, the U-shaped pipe of the cooling trap 72 is filled with liquid nitrogen 76, and a message of cooling is displayed (steps 18 and 19). After cooling for a predetermined period of time (step 20), the agitator 5 rotates in the reaction tank 2 to start the agitation operation. The hydrochloric acid pump 58 is operated for a predetermined period of time, so that a predetermined quantity of hydrochloric acid is supplied to the reaction tank, and a message of sampling is displayed (steps 21, 22 and 23). The additive pump 62 is operated for a predetermined period of time, so that a predetermined quantity of additive is added to the reaction tank 2 (step 24).

The ASC inserts the nozzle 50 in the sample solution (step 25). After a predetermined period of time, the syringe 40 is lowered by a predetermined amount, so that the sample solution is drawn in. The command “NU” is transmitted to raise the nozzle, so that the ASC pulls up the nozzle 50 from the sample solution. The syringe 40 is lowered, and the sample solution drawn into the nozzle 50 is transferred into the sample loop 42 (step 26). The sample valve 48 is switched to the reaction tank side (step 27). The syringe 40 is raised, and the sample solution inside the sample loop 42 is injected into the reaction tank 2 (step 28).

The NaBH₄ pump 10 is operated for a predetermined period of time in order to inject the hydrogenation reagent into the reaction tank 2 (step 29). The NaBH₄ injection valve 18 is repeatedly turned ON and OFF a predetermined number of times, so that a predetermined quantity of NaBH₄ solution is injected into the reaction tank 2 through the valve 8 (step 30). Accordingly, the sample solution reacts with NaBH₄ to generate the hydrides inside the reaction tank 2, and the hydrides are guided to the cooling trap 72 through the generated gas piping 38 and collected

After a predetermined period of time to complete the collection of the hydrides (steps 31 and 32), the measurement device performs the zero level adjustment (auto zero). Then, the measurement start signal is output, and a message of measurement is displayed (steps 33 and 34). When the measurement start signal is output, the U-shaped pipe of the cooling trap 72 is pulled up from liquid nitrogen (step 35). Accordingly, the hydrides collected in the cooling trap 72 are successively volatized from a form having a lower boiling point for separation. The boiling point separation is performed and the hydrides are successively introduced into the measurement device, thereby performing the measurement for a predetermined period of time (step 36).

After that, the drainage pump 6 is operated to discharge the reaction solution inside the reaction tank 2 (step 37). A message of the washing operation is displayed (step 38). After the ASC inserts the nozzle 50 into the washing port 54 (step 39), the washing operation of the nozzle 50 is performed through the switching of the syringe valve 44 and the operation of the syringe 40 (step 40). Then, the nozzle 50 is pulled up from the washing port 54 by the ASC (step 41), and the syringe 40 is lowered, so that air is drawn into the nozzle 50 to create an air gap (step 42).

The sample valve 48 is switched to the reaction tank side, and the drainage pump 6 starts, so that the sample path including the sample loop 42 and the sample piping 22 is washed by the switching of the syringe valve 44 and the operation of the syringe 40 (steps 43 and 44). After a predetermined period of time, the washing operation is stopped. The sample valve 48 is switched to the nozzle side, and the drainage pump 6 is stopped (steps 45 and 46).

The washing pump 66 is operated for a predetermined period of time to supply washing fluid to the reaction tank 2 (step 47), while the agitator 5 continues agitating. After stopping washing fluid and agitating for a predetermined period of time, the drainage pump 6 is operated to discharge washing fluid inside the reaction tank 2 and the agitator 5 stops (steps 48 and 49).

After a predetermined period of time, the helium valve 34 is opened for a predetermined period of time, and the operation for one sample solution is finished (step 50). A count value of the number of the samples is decremented by 1 (step 51), and the same operation is repeated until the number of the samples becomes 0.

According to the present invention, each step from the sample introduction to the hydride generation, the ultra-low temperature collection, and the boiling point separation is performed as a series inside the reaction tank connected with the piping. Accordingly, the process is controlled in a simple way through the controls of the individual processes as a series. It is also possible to reduce energy conserving by unifying as one apparatus, and shorten the processing time and improve the measurement precision.

In a conventional device, it takes more than ten minutes for one round of the processing from the sampling to the end due to separate processing operations. In the present invention, it is possible to complete one round of the processing within five minutes. It is also possible to improve precision of the processing, and reduce reproducibility of iterative measurement in an atomic absorption method within 10% as compared with 20% in a conventional measurement.

While the operator manually performs the processing in the conventional device, according to the present invention, it is possible to simplify the processing just to preparation of the sample and operation of the apparatus (key input).

The disclosure of Japanese Patent Application No. 2002-378975, filed on Dec. 27, 2002, is incorporated herein.

While the invention has been explained with reference to the specific embodiments of the invention, the explanation is illustrative and the invention is limited only by the appended claims.

What is claimed is:

1. A sample preprocessing method for converting a substance to be measured in a sample into volatile hydrides, comprising the steps of:
measuring a predetermined quantity of a sample and introducing the sample into a reaction tank of a reaction apparatus,
reacting the sample with a reagent for hydrogenation reaction in the reaction tank to produce volatile hydrides of the substance to be measured,
introducing the hydrides to a cooling trap for collection,
raising a temperature of the cooling trap gradually to sequentially separate a hydride with a low boiling point according to a boiling point, and
introducing the hydrides sequentially to the analytical device.

2. A sample preprocessing method according to claim 1, wherein each of the steps is performed sequentially inside the reaction apparatus connected to the analytical device with piping.

3. A sample preprocessing apparatus, comprising:
a reaction tank,
a sampling mechanism connected to the reaction tank for measuring a sample and supplying the sample to the reaction tank,
a reagent supply mechanism connected to the reaction tank for supplying a predetermined quantity of a reagent to the reaction tank,
a carrier gas supply mechanism connected to the reaction tank for supplying a carrier gas to the reaction tank, and
a cooling trap connected to the reaction tank for cooling hydrides together with the carrier gas sent from the reaction tank to collect the same, said cooling trap being capable of changing a temperature from a cooling temperature to a temperature higher than a highest boiling point of the hydrides for collection.

4. A sample processing apparatus according to claim 3, further comprising a sample piping situated between the reaction tank and the sampling mechanism for supplying the sample, a reagent piping situated between the reaction tank and the reagent supply mechanism for supplying the reagent, a carrier gas piping situated between the reaction tank and the carrier gas supply mechanism for supplying the carrier gas, and a generated gas piping situated between the reaction tank and the cooling trap for extracting the hydrides together with the carrier gas.

5. A sample preprocessing apparatus according to claim 3, further comprising a washing fluid piping connected to the reaction tank for supplying washing fluid and a drainage mechanism connected to the reaction tank for discharging a content of the reaction tank.

6. A sample preprocessing apparatus according to claim 3, wherein said reaction tank includes a top portion, and a bottom portion having a cross section smaller than that of the top portion.

7. A sample preprocessing apparatus according to claim 3, further comprising an agitating mechanism for agitating a content of the reaction tank.

8. A sample preprocessing apparatus according to claim 4, wherein said carrier gas piping has a carrier gas exit disposed at a bottom portion of the reaction tank.

9. A sample preprocessing apparatus according to claim 4, further comprising a steam trap disposed in the generated gas piping between the reaction tank and the cooling trap for trapping steam.

10. A sample preprocessing apparatus according to claim 4, further comprising a carbonic acid gas trap disposed in the generated gas piping between the reaction tank and the cooling trap for trapping carbonic acid gas.

11. A sample preprocessing apparatus according to claim 3, further comprising a control device for controlling the sampling mechanism, the reagent supply mechanism and the carrier gas supply mechanism to perform a series of steps including measuring a predetermined quantity of the sample and introducing the sample into the reaction tank, reacting the sample with the reagent in the reaction tank to produce volatile hydrides, introducing the hydrides to the cooling trap to be collected, raising a temperature of the cooling trap to sequentially separate a hydride with a low boiling point according a boiling point thereof, and introducing the hydrides to an analytical device.

12. A sample preprocessing apparatus according to claim 11, wherein said control device controls the sampling mechanism, the reagent supply mechanism, and the carrier gas supply mechanism to perform the series of the operations in a manual mode, in which each of the operations is performed when an instruction is input.

13. A sample preprocessing apparatus according to claim 11, wherein said control device controls the sampling mechanism, the reagent supply mechanism, and the carrier gas supply mechanism to perform the series of the operations in an auto mode, in which the operations are automatically performed according to a predetermined timing.
